(19) United States
(12) Patent Application Publication
(10) Pub. No.: US 2023/0134608 A1
(43) Pub. Date: May 4, 2023

(54) MULTI-PURPOSE MAT SYSTEM

(71) Applicant: GUANGTIAN WANG, Hacienda Heights, CA (US)

(72) Inventor: GUANGTIAN WANG, Hacienda Heights, CA (US)

(21) Appl. No.: 17/517,388

(22) Filed: Nov. 2, 2021

(51) Int. Cl. A61G 1/01; A61G 1/013; A61G 1/04

(52) U.S. Cl. CPC A61G 1/01; A61G 1/013; A61G 1/042

(57) ABSTRACT

A multi-purpose mat system includes a mat, the mat having a left side and a right side opposite of the left side; a plurality of loops spacedly formed on the left side and the right side; at least one support frame detachably coupled with the loops, each of the support frame having a plurality of support members detachably coupled with one another to form the support frame; wherein the mat is folded to form a tunnel with the loops being aligned with one another and the support frames being passed through the loops and the tunnel.

### FIELD OF THE DISCLOSURE

The present disclosure relates to a mat system, and particularly to a multi-purpose mat system suitable for utilizing as a picnic mat, a flag, or a folding stretcher. The support frame of the mat system may enable to be collapsed into smaller pieces with the mat being folding in a compact size in order to facilitate the transportation.

### BACKGROUND OF THE DISCLOSURE

Generally, any number of method and systems have been utilized to move a patient from one location to another. The patients could be moved or transported by a conventional stretcher or bed by several attendants. The portable stretcher are popular and well known devices which function well under most circumstances, and the conventional portable stretcher usually comprises a fabric sheet supported by the support frames in order to support the patient on the fabric sheet, However because these stretchers are bulky and heavy, they occupy a large space for storage when the spaces in the vehicle or ambulance have been already limited.

In some situations, it is preferable that the portable stretcher can be collapsed in a compact size. Many of the improved portable stretchers have been developed to enable the stretcher to be folded into a compact folded state to facilitate carrying and transportation. However, even if the current foldable stretcher could be stored in a relative smaller space, it could not be able to utilize in any time if people forget to put it in the vehicle. Accidents happen unexpectedly and people could not always have the stretcher in hand.

In another non-limiting example, currently-available foldable stretcher have several joints where the support frames are connected at, and the foldable stretcher could be folded via the joints. However, these joints affects the overall structure of the stretcher. Another drawbacks for the current-available foldable stretcher is that the overall structure is not strong enough to overcome an average weight of the body, and in such situation, the body may flip over or fall down therefrom during the transportation.

To overcome this known problem, there may exist a desire to develop a multi-purpose mat for utilizing in various kinds of purposes, such as picnic mats, flags, or stretchers. Therefore, people could store or bring the mat by the side so as to face emergency situations.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The disclosed embodiments may seek to satisfy one or more of the above-mentioned desires. Although the present embodiments may obviate one or more of the above-mentioned desires, it should be understood that some aspects of the embodiments might not necessarily obviate them.

### BRIEF SUMMARY OF THE DISCLOSURE

In a general implementation, the multi-purpose mat system comprises a mat, the mat having a left side and a right side opposite of the left side; a plurality of loops spacedly formed on the left side and the right side; at least one support frame detachably coupled with the loops, each of the support frame having a plurality of support members detachably coupled with one another to form the support frame; wherein the mat is folded to form a tunnel with the loops being aligned with one another and the support frames being passed through the loops and the tunnel.

In another aspect combinable with the general implementation, the tunnel bisects the mat.

In another aspect combinable with the general implementation, the loops comprises a plurality of right loops formed on the right side and a plurality of left loops formed on the left side, wherein the support frames are passed through the left loops and the right loops.

In another aspect combinable with the general implementation, the support frame comprises a first support frame and a second support frame, wherein the first support frame and the second support frame are passed through the loops of the mat.

In another aspect combinable with the general implementation, the support frame comprises a first support frame passed through a plurality of right loops formed on the right side of the mat, and a second support frame passed through a plurality of left loops formed on the left side of the mat.

In another aspect combinable with the general implementation, the support frame comprises a first support frame and a second support frame, wherein the first support frame comprises a plurality of first support members detachably coupled with one another, and the second support frame comprises a plurality of second support members detachably coupled with one another.

In another aspect combinable with the general implementation, the support frame comprises a first support frame and a second support frame, wherein the first support frame is passed through loops formed on the right side and the left side of the mat and the second support frame is passed through the tunnel formed by the mat.

In another aspect combinable with the general implementation, the loops comprises a plurality of right loops formed on the right side and a plurality of left loops formed on the left side, wherein each of the right loops is parallel alignment with one of a plurality of left loops formed on the left side.

In another aspect combinable with the general implementation, the loops comprises a plurality of right loops formed on the right side and a plurality of left loops formed on the left side, wherein each of the right loops is spacedly arranged with one another in an equal distance, wherein each of the left loops is spacedly arranged with one another in an equal distance.

In another aspect combinable with the general implementation, the mat further comprises a front side and a rear side opposite of the front side, wherein the front side and the rear side have no loops formed thereon.

In another aspect combinable with the general implementation, the mat is a rectangular shape.

In another aspect combinable with the general implementation, the mat is a square shape.

In another aspect combinable with the general implementation, the system further comprises a front side and a rear side opposite of the front side, wherein lengths of the front side and the rear side are shorter than lengths of the right side and the left side.

In another aspect combinable with the general implementation, the mat comprises four corners where the loops are formed thereon.

In another aspect combinable with the general implementation, the mat comprises a top face and a bottom face opposite of the top face, wherein each of the loops are coupled on the same side, which is either the top face or the bottom face of the mat.

In another aspect combinable with the general implementation, the loops comprises a plurality of right loops formed on the right side and a plurality of left loops formed on the left side, wherein each of the right loops and each of the left loops are coupled on the same side, either the top face or the bottom face of the mat.

In another aspect combinable with the general implementation, one of the plurality of support members has first end detachably coupled with the other one of the support members and a second end having a protrusion.

Another aspect of the embodiment is directed to methods of using a multi-purpose mat system, comprising:

providing a mat having a plurality of loops formed on a right side and a left side of the mat;

folding the mat to form a tunnel with the plurality of loops being aligned with one another;

coupling a plurality of support members with each other to form the support frames; and

passing one of the support frames through the plurality of loops.

In another aspect combinable with the general implementation, the method further comprises a step of passing the other one of the support frames through the tunnel.

In another aspect combinable with the general implementation, the tunnel bisects the mat.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above and below as acting in certain combinations and even initially claimed as such, one or more features from a claimed combination can in some cases be excised from the combination, and the claimed combination may be directed to a subcombination or variation of a subcombination.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

It should be noted that the drawing figures may be in simplified form and might not be to precise scale. In reference to the disclosure herein, for purposes of convenience and clarity only, directional terms such as top, bottom, left, right, up, down, over, above, below, beneath, rear, front, distal, and proximal are used with respect to the accompanying drawings. Such directional terms should not be construed to limit the scope of the embodiment in any manner.

FIG. 1 is a perspective view of a mat of a multi-purpose mat system according to an embodiment.

FIG. 2 is perspective view of a mat with at least one support frame of the multi-purpose mat system according to the embodiment.

FIG. 3 is a perspective view of a mat in a folded state with the support frames being detached from each other according to the embodiment.

FIG. 4 is a perspective view of the mat coupled with one of the support frame (either a first support frame or a second support frame) according to the embodiment.

FIG. 5 is a perspective view of the mat coupled with the first support frame and the second support frame according to the embodiment.

FIG. 6 is a perspective view of the multi-purpose mat system according to the embodiment, showing the mat being utilized as the folding stretcher.

### DETAILED DESCRIPTION OF THE EMBODIMENTS

The different aspects of the various embodiments can now be better understood by turning to the following detailed description of the embodiments, which are presented as illustrated examples of the embodiments defined in the claims. It is expressly understood that the embodiments as defined by the claims may be broader than the illustrated embodiments described below.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

It shall be understood that the term “means,” as used herein, shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

Unless defined otherwise, all technical and position terms used herein have the same meaning as commonly understood by one of ordinary skill in the art to which the invention pertains. Although many methods and materials similar, modified, or equivalent to those described herein can be used in the practice of the present invention without undue experimentation, the preferred materials and methods are described herein. In describing and claiming the present invention, the following terminology will be used in accordance with the definitions set out below.

As used herein, a folding stretcher refers to a functionally transporting device which is able to transport a body and support the body above the ground.

A “right side”, a “left side”, a “front side”, and a “rear side” refers to a “peripheral side/edge” of a mat, as used herein, refers to the external boundary of the mat. The “right side”, the “left side”, the “front side”, and the “rear side” can include a fold or hem formed along the right side, the left side, the front side, and the rear side respectively. The fold or hem in the invention is typically strengthened with reinforcement.

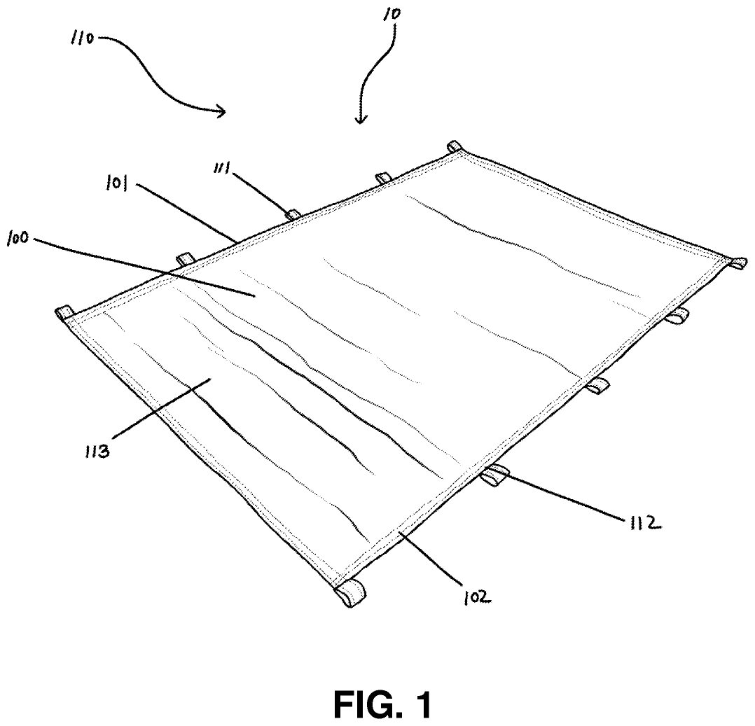

FIG. 1 generally depicts a mat 100 of a multi-purpose mat system 10 according to an embodiment.

Referring to FIG. 1, the multi-purpose mat system 10 comprises the mat 100 having a left side 101 and a right side 102 opposite of the left side 101, and a plurality of loops 110 spacedly formed on the left side 101 and the right side 102 of the mat 100.

In an embodiment, the plurality of loops 110 comprises a plurality of right loops 112 formed on the right side 102 and a plurality of left loops 111 arranged on the left side 101, and each of the right loops 112 may be parallel alignment with each one of the plurality of left loops 111 formed on the left side 101.

In an embodiment, each of the right loops 112 can be spacedly arranged with one another in an equal distance, wherein each of the left loops 111 can be spacedly arranged with one another in an equal distance. Here, each of the right loops 112 can be spacedly arranged with one another in a distance which is the same as a distance that each of the left loops 111 is spacedly arranged with.

In an embodiment, each of the right loops 112 can be spacedly arranged with one another in different distances, and each of the left loops 111 can be spacedly arranged with one another in different distances.

It is noted that the mat 100 could be made of a plastic material or any kind of waterproof material. The contemplated mat 100 can be made of suitable materials to withstand temperature extreme and the chemical environment, such materials include natural and synthetic polymers, textile fibers and all reasonable combinations thereof.

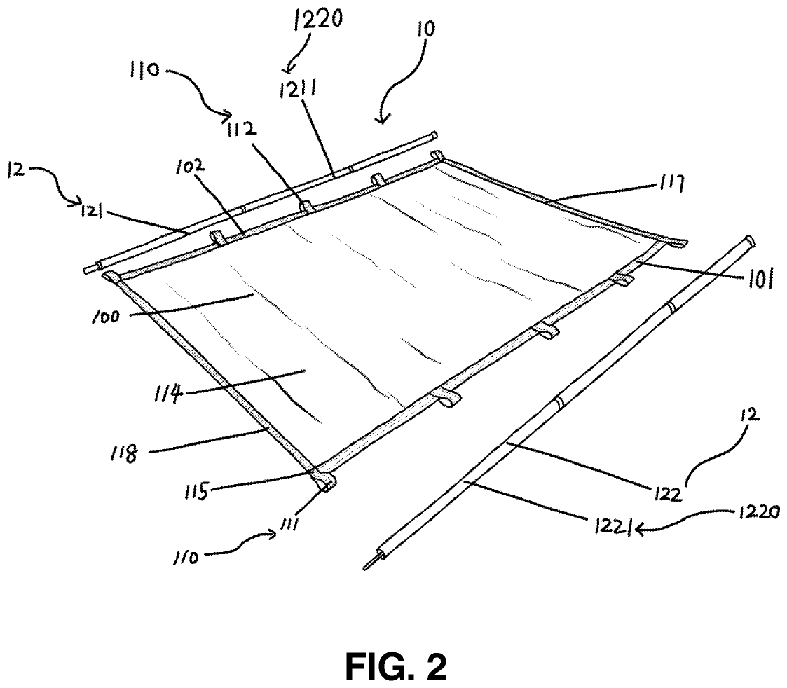

FIG. 2 generally depicts the multi-purpose mat system 10 according to an embodiment.

Referring to FIG. 2, the multi-purpose mat system 10 further comprises at least one support frame 12 detachably coupled with the loops 110, wherein each of the support frame 12 comprises a plurality of support members 1220 detachably coupled with one another to form the support frame 12. In an embodiment, the support frame 12 comprises a first support frame 122 and a second support frame 121, and the first support frame 122 comprises a plurality of first support members 1221 detachably coupled with one another, and the second support frame 121 comprises a plurality of second support members 1211 detachably coupled with one another.

It is noted that, as shown in FIG. 1 and FIG. 2, the mat 100 comprises a top face 113 and a bottom face 114 opposite of the top face 113, wherein each of the loops 110, including the right loops 112 and the left loops 111, may be arranged (stitched) on the same face, which is either the top face 113 or the bottom face 114 of the mat 100.

In an embodiment, referring to FIG. 2, each of the right loops 112 can be attached on the bottom face 114 of the mat 100 and along the right side 102 of the mat 100, and each of the left loops 111 can be formed (stitched) on the bottom face 114 of the mat 100 and along the left side 101 of the mat 100. Here, the mat 100 further comprises corners 115 where the loops 110 are formed thereon.

In the embodiment of FIG. 2, the mat 100 can be a rectangular shape. The mat 100 may be a square shape based on the needs of the purposes. Here, the mat 100 further comprises a front side 117 and a rear side 118 opposite of the front side 117, wherein the front side 117 and the rear side 118 have no loops formed thereon. For example, the loops 110, including the right loops 112 and the left loops 111, may be formed on two opposite sides of the mat 100, and the rest of the sides (the front side 117 and the rear side 118) have no loops formed thereon. It is noted that the two opposite sides having the right loops 112 and the left loops 111 are two parallelly arranged sides, and in such way, each of the right loops 112 can be arranged in parallel alignment with each one of the left loops 111 in order to perform the function of the mat system 10.

According to the embodiment, lengths of the front side 117 and the rear side 118 may be shorter than lengths of the right side 102 and the left side 101. Or, alternatively, lengths of the front side 117 and the rear side 118 may be longer than lengths of the right side 102 and the left side 101.

In an embodiment, the loops 110, including the right loops 112 and the left loops 111, may be formed on the corners 115 of the mat 100. For example, as shown in FIG. 2, one of the loops 110, either the right loop 112 or the left loop 111, may be formed on each of the corners 115 of the mat 100.

Accordingly, in an embodiment, each of the loops 110, including the right loops 112 and the left loops 111, is formed by a strap being folded to from each of the loop shape, wherein each of the straps, configurated to from the loops, has an equal length, or an approximately equal length. Here, the lengths of the straps can be pre-designed based on diameters of the first support frame 122 and diameters of the second support frame 121. For example, a diameter of each of the loops 110 may be predesigned to slightly larger than a diameter of the first support frame 122 and a diameter of the second support frame 121.

In an embodiment, a length of the first support frame 122 may be longer than the length of the right side 102 and the length of the left side 101 of the mat 100. Here, the length of the first support frame 122 may be longer than the length of the front side 117 and the length of the rear side 118 of the mat 100.

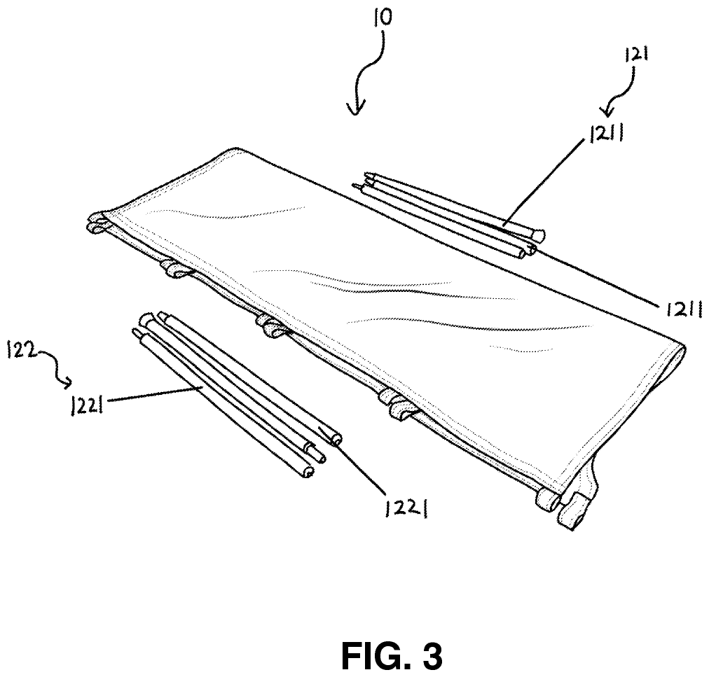

FIG. 3 generally depicts the multi-purpose mat system 10 according to an embodiment, showing the support frame, including the first support frame 122 and the second support frame 121, being detached into a plurality of support members.

Referring to FIG. 3, the first support frame 122 comprises a plurality of first support members 1221 and the second support frame 121 comprises a plurality of second support members 1211. In an embodiment, a length of each of the first support members 1221 can be pre-designed, and for example, each of the length of each of the first support members 1221 can be equal. A length of each of the second support members 1211 can be pre-designed, and for example, each of the length of the second support members 1211 can be equal. It is noted that the length of each of the first support members 1221 can be equal to the length of each of the second support members 1211. Therefore, a length of the first support frame 122 may be equal to the a length of the second support frame 121.

In an embodiment, the first support members 1221 and the second support members 1211 may be made of light metal such as, aluminum.

It should be understood that the above-described material is exemplary and any other materials can be adopted in various embodiments of this disclosure.

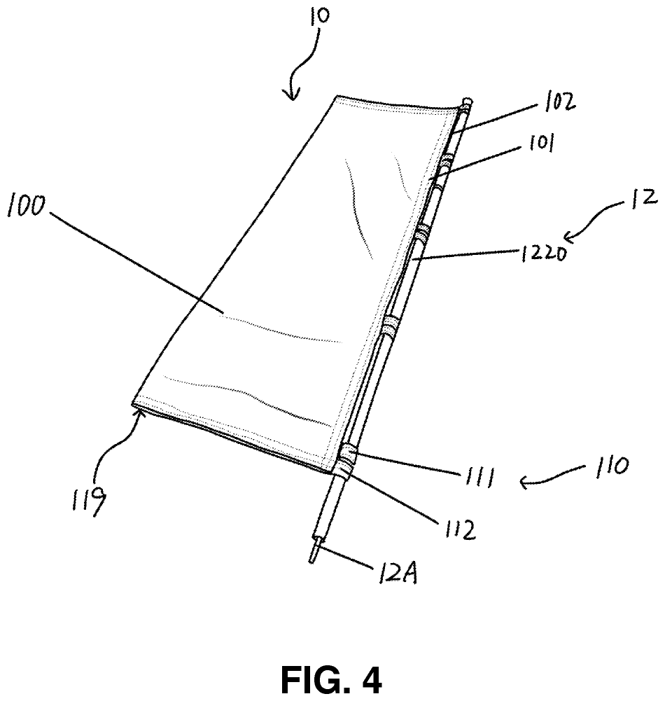

FIG. 4 generally depicts the multi-purpose mat system 10 according to an embodiment, showing the support frame 12 being passed through the loops 110, wherein the support members 1220 can be coupled with each other to form the support frame 12.

Referring to FIG. 4, the mat 100 may be folded to form a tunnel 119, and in an embodiment, the mat 100 may be folded in a half with that the tunnel 119 bisects the mat 100. In such way, each of the right loops 112 may be parallel alignment with each of the left loops 111. For example, the loops 110, including the right loops 112 and the left loops 111, may be aligned with one another with that the support frames 12 can be passed through each of the loops 110, including the right loops 112 and the left loops 111.

In an embodiment, one of the plurality of support members 12 has first end detachably coupled with the other one of the support members 12 and a second end having a protrusion 12A. As shown in FIG. 4, the length of the support frame 12 may be longer than the length of the right side 102 and the left side 101 of the mat 100, and in such manner, while the support frame 12 is passed through the right loops 112 and the left loops 111, the protrusion 12A of one of the support members 1220 may be adopted to insert into the ground in order to support the mat 100 being suspended above the ground. Therefore, the multi-purpose mat system 10 may be utilized as a flag for specifical needs.

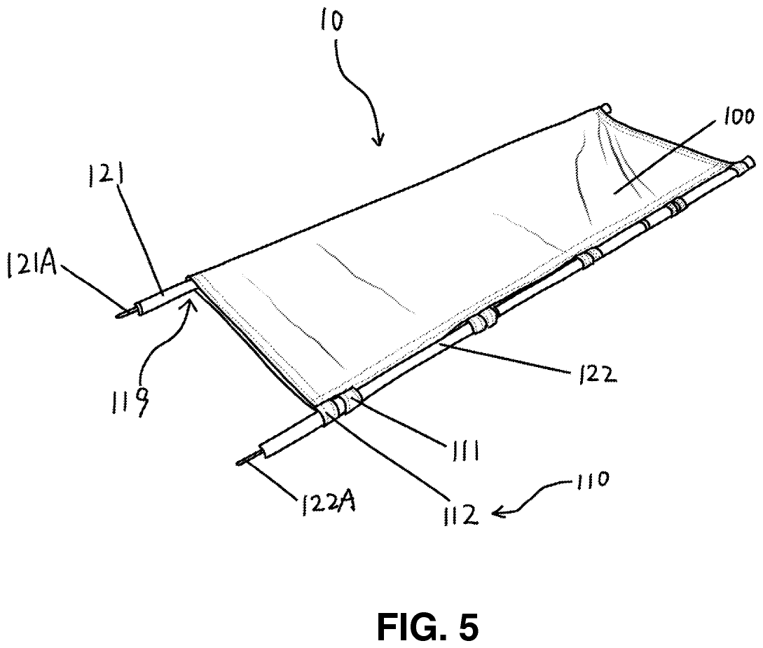

FIG. 5 generally depicts the multi-purpose mat system 10 according to an embodiment.

Referring to FIG. 5, in an embodiment, the mat 100 may be folded in a half to form the tunnel 119 along the central line of the mat 100, and the right loops 112 and the left loops 111 may be aligned with each other. In this manner, the first support frame 122 may be passed through each of the left loops 111 and each of the right loops 112, wherein the first support frame 122 comprises the plurality of the first support members 1221 being detachably coupled with each other, as shown details in FIG. 3. Here, one of the first support members 1221 may comprise one end detachably coupled with the other one of the first support members 1221 and an opposite end having a first protrusion 122A.

According to the embodiment of FIG. 5, the second support frame 121 may be passed through the tunnel 119 formed by the folded mat. In this manner, the second support frame 121 comprises the plurality of second support members 1211 (as shown in FIG. 3) being coupled with each other, wherein one of the second support members 1211 (as shown in FIG. 3) has one end detachably coupled with the other one of the second support members 1211 and an opposite end having a second protrusion 121A.

In an embodiment, the length of the first support frame 122 and the length of the second support frame 121 may be shorter than or equal to the length of the right side and the length of the left side of the mat 100.

It is noted that, in an embodiment, the length of the first support frame 122 may be equal or different to the length of the second support frame 121, and the diameter of the first support frame 122 may be equal to or different with the diameter of the second support frame 121. Here, the diameter of the first support frame 122 and the diameter of the second support frame 121 may be slightly smaller than the diameter of each of the left loops 111 and each of the right loops 112, and in this way, the first support frame 122 can be selectively passed through the right loops 112 and/or the left loops 111, and the second support frame 121 can be selectively passed through the tunnel 119.

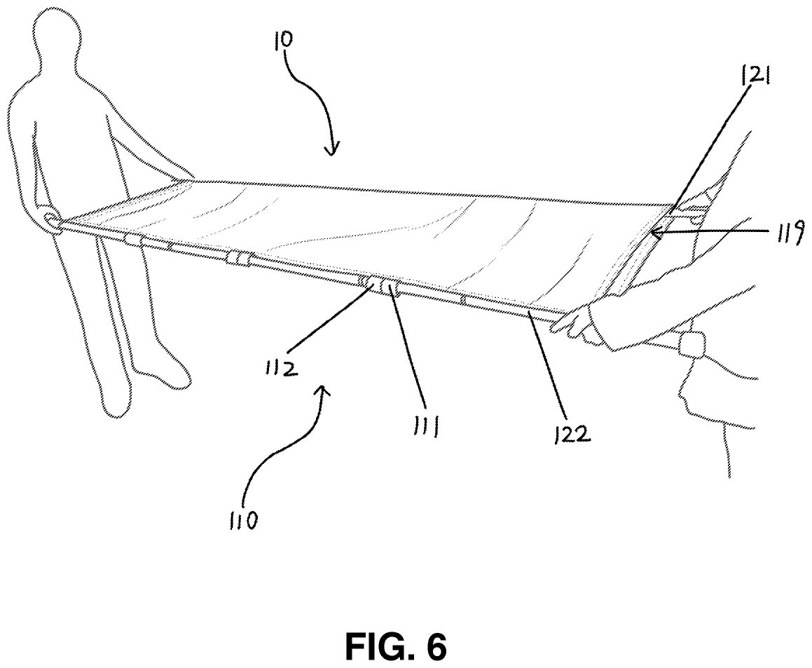

FIG. 6 generally depicts the multi-purpose mat system 10 according to an embodiment, showing the multi-purpose mat system 10 utilized as a folding stretcher for transporting the patients.

Continuing to FIG. 6, the first support frame 122 may be passed through the right loops 112 and the left loops 111 and biased against inner surfaces of each of the right loops 112 and the left loops 111, and the second support frame 121 is passed through the tunnel 119 formed by the mat 100.

In an embodiment, several attendants may be able to hold on the two opposite ends of the first support frame 122 and the second support frame 121 and lift the mat 100 with the patient's body lying thereon in order to transport the patient's body.

Referring to FIGS. 1-6, the contemplated embodiment may include a method of using a multi-purpose mat system 10, comprising:

a providing step to provide a mat 100 having a plurality of loops 110 formed on a right side 102 and a left side 101 of the mat 100;

a folding step to fold the mat 100 to form a tunnel 119 with the plurality of loops 110 being aligned with one another;

a coupling step to detachably couple a plurality of support members 1220 with each other to form the support frames 12; and

a passing step to pass one of the support frames 12 (e.g., the first support frame 122) through the plurality of loops 110.

According to the method of using the multi-purpose mat system 10, the method further comprises another passing step to pass the other one of the support frame (e.g., the second support frame 121) through the tunnel 119. Here, the tunnel 119 may bisect the mat 100.

According to the method of using the multi-purpose mat system 10, the providing step further comprises another providing step to provide all of the loops 100 on either the top face 113 or the bottom face 114 of the mat 100, wherein the top face 113 may be opposite of the bottom face 114.

In an embodiment, the loops 110 may comprise the plurality of right loops 112 formed along the right side 102 of the mat, wherein each of the right loops 112 may spacedly along on the right side 102 of the mat 100 with an equal distance or with a different distance.

In an embodiment, the loops 110 may comprise the plurality of left loops 111 formed along the left side 101 of the mat 100, wherein each of the left loops 111 may spacedly arrange on the left side 101 of the mat 100 with an equal distance or with a different distance. Here, each of the right loops 112 may spacedly arrange on the right side 102 of the mat 100 with a distance which is the same as the distance where each of the left loops 111 is spacedly arranged with. For another example, each of the right loops 112 may spacedly arranged on the right side 102 of the mat 100 with the distance which is different than the distance where each of the left loops 111 is spacedly arranged with on the left side 101.

It is noted that each of the loops 110, including the right loops 112 and the left loops 111, may be spacedly stitched on the mat 100 with a pre-determined distance, wherein the pre-determined distance is pre-designed as required. The above described embodiments are examples offered to illustrate, but not to limit the claimed invention.

In an embodiment, each of the left loops 111 may be parallelly arranged with respect to each of the right loops 112. For example, the left loops 111 and the right loops 112 may be parallelly arranged on two opposite sides of the mat 100 respectively. Here, left loops 111 and the right loops 112 may be arranged on the left side 101 and the right side 102 of the mat 100 respectively, and the front side 117 and the rear side 118 of the mat 100 have no loops formed thereon. For another example, the left loops 111 and the right loops 112 may be stitched on the right side 102 and the left side 101 of the mat 100, and the front side 117 and the rear side 118 may selectively comprise the loops 110.

In an embodiment, the left loops 111 and the right loops 112 may be stitched on the front side 117 and the rear side 118 of the mat, and the right side 102 and the left side 101 may selectively comprise the loops 110.

In an embodiment, the support frames 12 may comprise the first support frame 122 (one of the support frame) and the second support frame 121 (the other one of the support frame), wherein the first support frame 122 and the second support frame 121 could be two identical frames. Here, the first support frame 122 comprises the plurality of the first support members 1221 which could be detachably coupled with each other, and the second support frame 121 comprises the plurality of the second support members 1211 which could be detachably coupled with each other.

Accordingly, in an embodiment, the plurality of the first support members 1221 could be coupled with each other by various kinds of connection method and the plurality of the second support members 1211 could be coupled with each other by various kinds of connection method. For example, each of the first support members 1221 and the second support members 1211 may selectively comprise a screw portion or a bolt portion, wherein the screw portion may be configured to engage with the bolt portion to connect the first support member 1221 with one another (e.g., another one of the first support member 1221) and connect the second support member 1211 with one another (e.g., another one of the second support member 1211).

In an embodiment, the mat 100 can be a rectangular shape. The mat 100 may be a square shape based on the needs of the purposes.

It should be understood that the above-described shapes are exemplary and any other shapes which are adopted to fold the mat 100 in order to make the left loops 111 being aligned with the right loops112 can be utilized as the shape of the mat 100.

According to all of the embodiments described above, the front side 117, the rear side 118, the left side 101, and the right side 102 of the mat 100 may be folded towards either the top face 113 or the bottom face 114 of the mat 100, and to be sealed (or stitched) on the top face 113 or the bottom face 114 to form folds or stems. It is noted that the fold or stems may be able to enhance an overall structure of the mat 100.

According to all of the embodiments described above, the loops 110, including the right loops 112 and the left loops 111, may be stitched on the folds or stems of both of the right side 102 and the left side 101, or/and both of the front side 117 and the rear side 118. During the uses of the multi-purpose mat system 10, the support frame 12, including the first support frame 122 and the second support frame 121, may be biased against the loops 110, and in this manner, the loops 110 may sustain most of the weight of the patient's body supported on the mat 100. Therefore, the folds or stems could enhance the adhesion of the loops 110, including the right loops 112 and the left loops 111, and prevent the loops 110 bumping off or falling down from the mat 100.

Similarly, while operations and/or methods may be depicted in the drawings in a particular order, this should not be understood as requiring that such operations be performed in the particular order shown or in sequential order, or that all illustrated operations and/or method steps be performed, to achieve desirable results. In certain circumstances, multitasking and parallel processing may be advantageous.

Many alterations and modifications may be made by those having ordinary skill in the art without departing from the spirit and scope of the disclosed embodiments. Therefore, it must be understood that the illustrated embodiments have been set forth only for the purposes of example and that it should not be taken as limiting the embodiments as defined by the following claims. For example, notwithstanding the fact that the elements of a claim are set forth below in a certain combination, it must be expressly understood that the embodiment includes other combinations of fewer, more or different elements, which are disclosed herein even when not initially claimed in such combinations.

Thus, specific embodiments and applications of the multi-purpose mat system have been disclosed. It should be apparent, however, to those skilled in the art that many more modifications besides those already described are possible without departing from the disclosed concepts herein. The disclosed embodiments, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the embodiments. In addition, where the specification and claims refer to at least one of something selected from the group consisting of A, B, C and N, the text should be interpreted as requiring at least one element from the group which includes N, not A plus N, or B plus N, etc.

The words used in this specification to describe the various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

What is claimed is:

1. A multi-purpose mat system, comprising;
a mat, the mat having a left side and a right side opposite of the left side;
a plurality of loops spacedly arranged along the left side and the right side;
at least one support frame detachably coupled with the loops, each of the support frame having a plurality of support members detachably coupled with one another to form the support frame; wherein
the mat is folded to form a tunnel with the loops being aligned with one another and the support frames are passed through the loops and the tunnel.

2. The mat system of claim 1, wherein the tunnel bisects the mat.

3. The mat system of claim 1, wherein the loops comprises a plurality of right loops arranged on the right side and a plurality of left loops arranged on the left side, wherein the support frames are passed through the left loops and the right loops.

4. The mat system of claim 1, wherein the support frame comprises a first support frame and a second support frame, wherein the first support frame and the second support frame are passed through the loops of the mat.

5. The mat system of claim 1, wherein the support frame comprises a first support frame passed through a plurality of right loops arranged on the right side of the mat, and a second support frame passed through a plurality of left loops arranged on the left side of the mat.

6. The mat system of claim 1, wherein the support frame comprises a first support frame and a second support frame, wherein the first support frame comprises a plurality of first support members detachably coupled with one another, and the second support frame comprises a plurality of second support members detachably coupled with one another.

7. The mat system of claim 1, wherein the support frame comprises a first support frame and a second support frame, wherein the first support frame is passed through loops formed on the right side and the left side of the mat and the second support frame is passed through the tunnel formed by the mat.

8. The mat system of claim 1, wherein the loops comprises a plurality of right loops arranged on the right side of the mat and a plurality of left loops arranged on the left side of the mat, wherein each of the right loops is parallel alignment with each one of a plurality of left loops.

9. The mat system of claim 1, wherein the loops comprises a plurality of right loops arranged along the right side of the mat and a plurality of left loops arranged along the left side of the mat, wherein each of the plurality of the right loops is spacedly arranged with one another in an equal distance, wherein each of the plurality of the left loops is spacedly arranged with one another in an equal distance.

10. The mat system of claim 1, wherein the mat further comprises a front side and a rear side opposite of the front side, wherein the front side and the rear side have no loops formed thereon.

11. The system of claim 1, wherein the mat is a rectangular shape.

12. The system of claim 1, wherein the mat is a square shape.

13. The system of claim 1, wherein the mat further comprises a front side and a rear side opposite of the front side, wherein a length of the front side and a length of the rear side are shorter than lengths of both of the right side and the left side.

14. The system of claim 1, wherein the mat further comprises corners where the loops are formed thereon.

15. The system of claim 1, wherein the mat further comprises a top face and a bottom face opposite of the top face, wherein each of the loops are coupled on the same face, which is either the top face or the bottom face of the mat.

16. The system of claim 15, wherein the loops comprises a plurality of right loops arranged on the right side of the mat and a plurality of left loops arranged on the left side of the mat, wherein each of the right loops and each of the left loops are coupled on the same side, either the top face or the bottom face of the mat.

17. The system of claim 1, wherein one of the plurality of support members has a first end detachably coupled with the other one of the support members and a second end having a protrusion.

18. A method of using a multi-purpose mat system, comprising:
providing a mat having a plurality of loops arranged along a right side and a left side of the mat;
folding the mat to form a tunnel with the plurality of loops being aligned with one another;
detachably coupling a plurality of support members with each other to form the support frames; and
passing one of the support frames through the plurality of loops.

19. The method of claim 1, further comprising passing the other one of the support frames through the tunnel.

20. The method of claim 1, wherein the tunnel bisects the mat.
